(19) United States
(12) Patent Application Publication
(10) Pub. No.: US 2003/0167325 A1
(43) Pub. Date: Sep. 4, 2003

(54) Network based middleware that manipulates media objects

(76) Inventors: Ashesh C. Shah, Boston, MA (US); Palle Pedersen, Boston, MA (US); Niksa Radovic, Somerville, MA (US); Senthilkumar Manickavasagam, Randolph, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/277,723

(22) Filed: Oct. 21, 2002

Related U.S. Application Data
(63) Continuation of application No. 09/617,700, filed on Jul. 17, 2000, now abandoned.
Application No. 09/617,700 is a continuation of application No. 08/879,841, filed on Jun. 20, 1997, now abandoned.
(60) Provisional application No. 60/020,094, filed on Jun. 21, 1996.

(51) Int. Cl. G06F 15/173

(52) U.S. Cl. 709/224

(57) ABSTRACT

The media manipulator is a middle layer between the clients and the remote data servers is the common client-server organization. It transforms the network into a more flexible three-tiered configuration. Requests generated by the clients for media objects from media resources are routed to the media manipulator. It processes the requests and determines if the media objects may be found locally, either cached in the media manipulator itself or in the local data servers. When the media objects are obtained, the media manipulator can be used to perform operations on those objects such as format translations, to apply protective mechanisms for the clients, to speed communications between the remote servers and the clients, or perform compute operations for the clients. In one example, a parser of the manipulator searches for images in the media objects so that service devices can be called to perform data compression or pornography detection on the images. The parser can also search for executable or data files in the media objects and to perform virus scanning or format conversion, respectively.

### RELATED APPLICATIONS

This application is a Continuation of U.S. application Ser. No. 09/617,700, filed Jul. 17, 2000, which is a Continuation of U.S. application Ser. No. 08/879,841, filed Jun. 20, 1997, which claims the benefit of U.S. Provisional Application No. 60/020,094, filed Jun. 21, 1996, the contents of which is incorporated herein by reference in their entirety.

### BACKGROUND OF THE INVENTION

In a client-server network, on one hand there are clients, typically personal computers, IBM-compatible computers and/or UNIX workstations, for example, equipped with information browsers. On the other hand, there are data servers and compute servers. Data servers are computers with a large storage capacity containing information in different media formats: data records, plain text documents, word processing documents, still pictures, compressed audio and video, and executable files, for example. Compute servers are computers that carry out intensive computational tasks that would typically require too much time for the client to complete. Each compute server might use a single or many processors to complete the given task.

Users interact with their clients in a natural way with a mouse, keyboard, screen, printer, or by some other input/output device. The users need not be concerned about what happens after they make their selection within their clients. Clients then make service requests to geographically dispersed servers. Upon receiving requests from the clients, the servers perform the desired operations and return the retrieved or computed media stream back to the client for display.

### SUMMARY OF THE INVENTION

The present invention is connected into the ubiquitous two-tiered client-server network of computers. It is designed as a middle layer, middleware, between the clients and the remote data servers. It transforms the network into a more flexible three-tiered configuration. Requests generated by the clients for media objects from media resources are routed to the media manipulator. It processes the requests and determines if the media objects may be found locally, either cached in the media manipulator itself or in local/remote data servers. When the media objects are obtained, the media manipulator can be used to perform operations on those objects such as format translations, to apply protective mechanisms for the clients such as virus scanning, to speed communications between the remote servers and the clients using compression operations, or perform compute operations for the clients.

In general, according to one aspect, the invention features a middle-ware computing system. It includes a network access system that supports communications with media resources and client computers and a media manipulation system that operates on media objects received from the media resources via the network access system prior to forwarding the media objects to the client computers.

In specific embodiments, a parser is used to identify different media types within the media objects so that service devices may be called to operate on the media types. In one example, the parser searches for images in the media objects and service devices include an image compressor for performing data compression or pornography detection on the images. The parser can also search for executable or data files in the media objects and the service devices then called to perform virus scanning or format conversion, respectively.

In further specifics, a cache is used to store media objects. A media flow manager receives requests for media objects and checks for the presence of the media objects in the cache to preclude the necessity of obtaining the objects from the remote media resources.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic block diagram illustrating the context in which the inventive media manipulator operates;

FIG. 2 is a block diagram illustrating the interaction between components of the media manipulator according to the invention;

FIG. 3 is an object interaction diagram illustrating the operation of the components of the media manipulator;

FIGS. 4A, 4B, and 4C show the message formats for transmitting tasks to compute servers;

FIG. 5 is a block diagram showing the programming of the media manipulator using m-script;

FIG. 6 is another object interaction diagram showing the order of creation of the components of the manipulator; and

FIG. 7 is a block diagram showing another embodiment of the media manipulator.

### DETAILED DESCRIPTION OF THE DRAWINGS

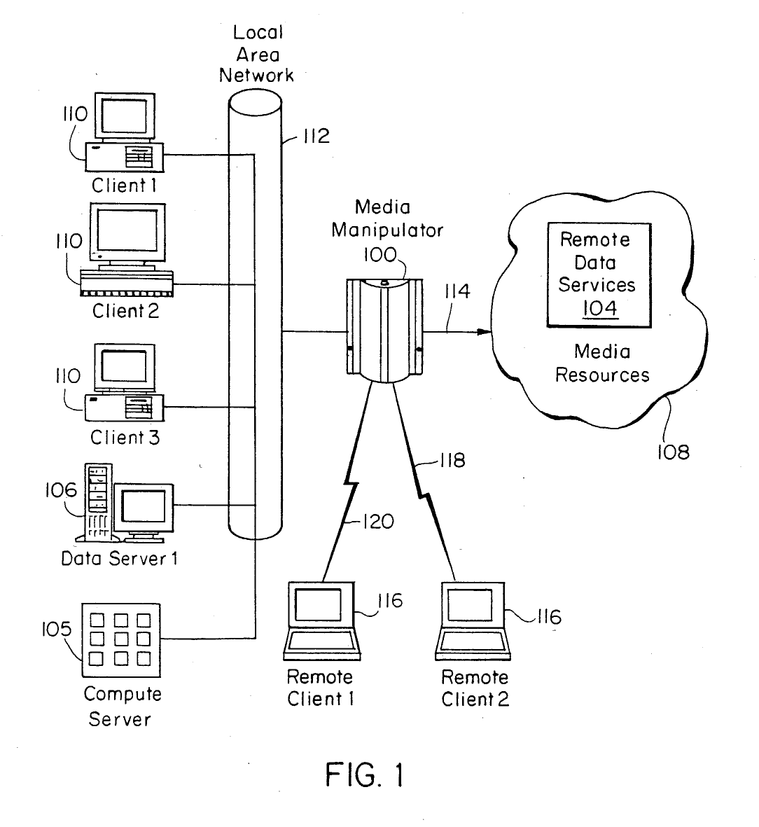

FIG. 1 illustrates the context in which the media manipulator 100 operates. In many applications, it is important for users to access remote media resources 108 such as the data servers 104 of content providers on the Internet. These users may be at client computers 110 that are inter-connected by a local area network (LAN) 112. The clients 110 access the media resources 108 through a gateway 114 linking the LAN 112 to the Internet. The user's also require access to the media resources 108 remotely at remote clients 116 through, for example, telephone dial-up connections 118 or through cellular/wireless links 120.

The media manipulator 100 is connected into this two-tiered client-server network of computers as a middle layer between the clients 110, 116 and the remote data servers 104 of the media resources 108.

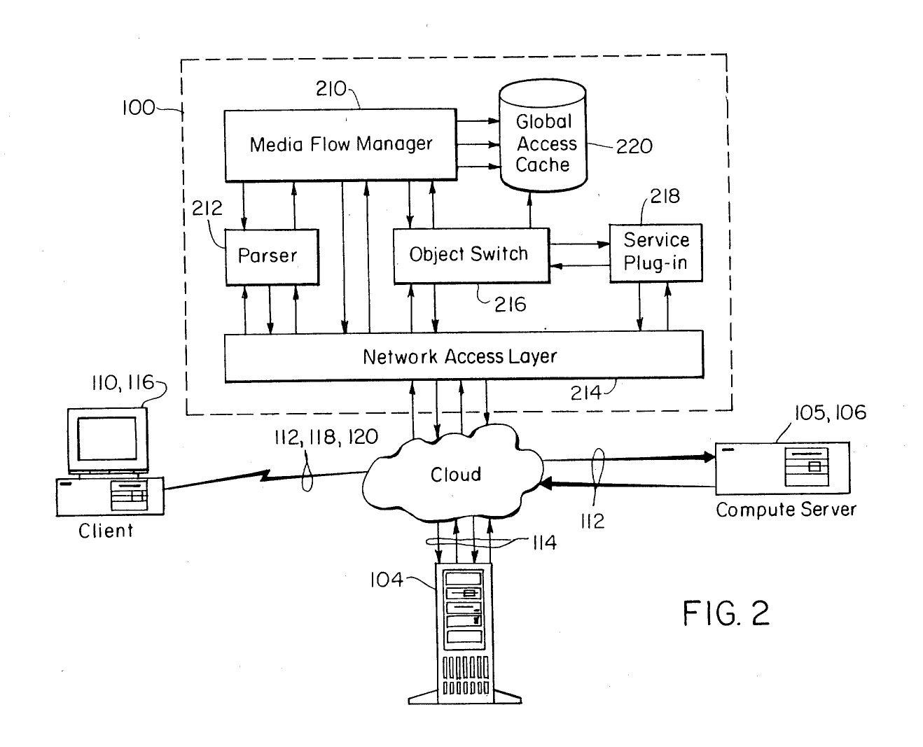

FIG. 2 is a block diagram illustrating the internal organization of the media manipulator 100. It comprises six basic components: media flow manager 210, media parser 212, network access layer 214, object switch 216, multiple service plugins 218, and global access cache 220. In one embodiment, these components are implemented as separate software objects that run on a common microprocessor or multiprocessor system.

The media flow manager 210 serves as the principle controller for the media manipulator 100. It has access to the various components and can alter their behavior. It specifies the operations to be formed on the received media objects. It is also the storehouse for the information on the media objects as they are received from the media parser. The media flow manager 210 also tracks the physical resources that are functional and available in the media manipulator and on the surrounding LAN in order to determine to which of the resources the media objects flow.

The network access layer 214 makes the media manipulator 100 accessible through many different types of network devices and the protocols running on top of them. In one implementation, the network access layer communicates through the Internet gateway 114 using the TCP/IP protocol, connects to the compute or data server using the protocol of the local area network 112, and communicates with the clients using either the LAN or the protocols necessary to communicate with the remote clients 116 over low-bandwidth connections 118, 120.

When communicating with the remote data servers 104 of the content providers, the network accepts the incoming data streams and assembles them into media objects. These media objects are then made available to the media parser 212, object switch 216, and service plugins 218. The media parser 212 analyses all incoming media objects to extract the relevant media types. These media types include executable files, data files, and images, for example. Information concerning the detected media types is forwarded to the media flow manager 210, which decides what operations should be performed on the media.

The object switch 216 supports a number of incoming and outgoing object gates. Media objects enter into the object switch from the network access layer 214 and from the service plugins' output links. The media objects leaving the object switch 216 go into the network access layer 214 and the service plugins' input links. The object switch routes the objects based on the media manager instructions, either directly or indirectly.

The global access cache is an intelligent mechanism that speeds the operation from the perspective of the user at the clients 110, 116. It determines which media objects are most likely to be used in the future and stores them in the fastest available memory. Media objects that are somewhat less likely to be required again are stored in slower memory or a secondary cache. There can be as many levels of the cache as the physical infrastructure allows, and the caching may take place on data servers that are remote from the main computational resources of the media manipulator. This caching minimizes the time that different users need to wait for requests to be processed.

The media manipulator 100 is a programmable device. A system administrator can change its behavior by giving it m-script commands. It is also an extendable device. By adding new service plugins, new capabilities can be added to the device. The construction of the components of the media manipulator allows for redundancy and fault tolerance. A hardware failure does not bring the entire system to a halt. The system will keep working and simply notify the administrator that one of its components needs to be replaced.

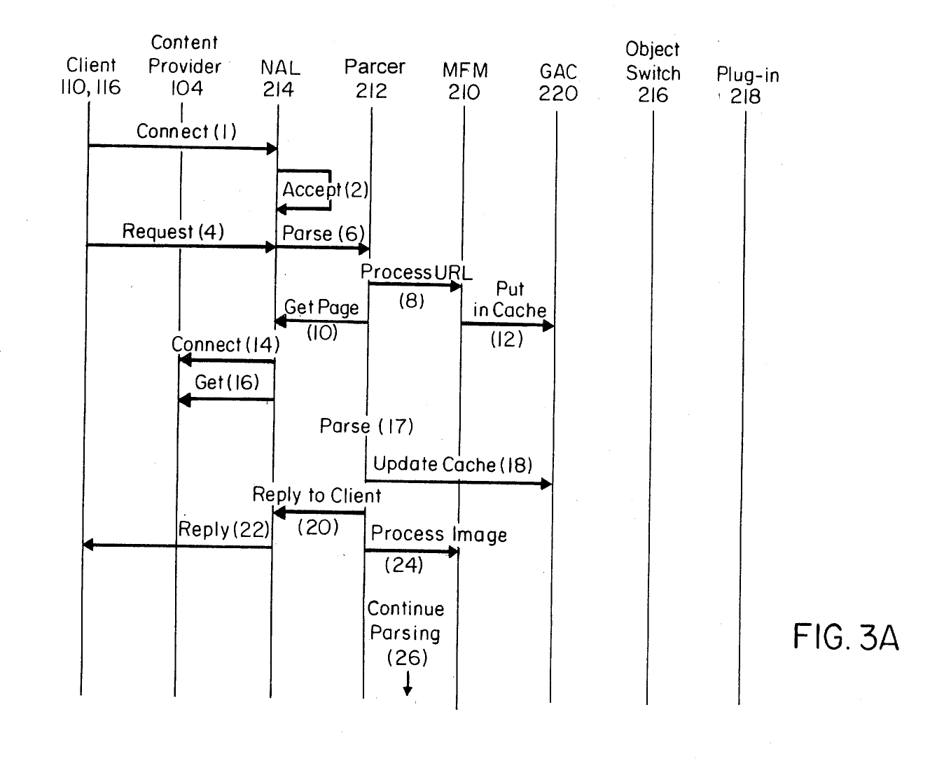

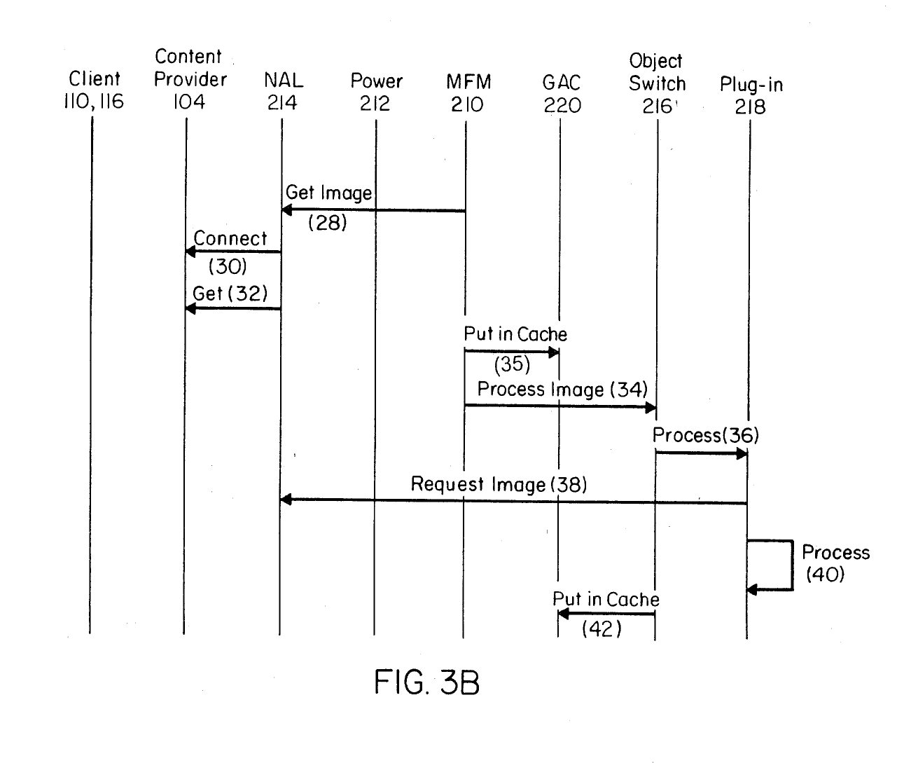

FIG. 3 is an object flow diagram illustrating the communication between the client 110, 116, content provider's data server 104, and the components of the multimedia manipulator 100.

The first step is the initial connection 1, Connect, between the client 110, 116 and the media manipulator 100 via the network access layer 214. The network access layer 214 accepts this request 2. In one implementation, it accepts by calling a new incidence of itself such that each incidence of the network access layer object supports a single connection outside the media manipulator 100.

After establishing the connection, the client makes a request 4 for a media object. In the typical example, this will be a universal resource locator (URL) to a data server 104 of a content provider on the Internet. The network access layer then calls the media parser 212 and passes the client request 6.

The media parser 212 looks to two sources for the media object simultaneously. The ProcessURL request 8 is passed to the media flow manager 212, which has knowledge of the contents of the global access cache 220. The parser also issues a request 10, GetPage, to the network access layer.

The media flow manager 212 searches for the object in the cache 220. If the cache returns a cache-miss, the request to the provider has not been delayed waiting for the miss status, whereas in the case of a cache-hit, the request to the provider is simply terminated after verifying the validity of the cached page. Using this scheme, there is little increased latency associated with the use of the manipulator 100 in the worst-case cache-miss scenario.

In the illustrated example, a cache-miss occurred. Thus, rather than supplying the object, the cache 220 is prepared 12 to receive the media object, PutInCache. Also, the network access layer 214 connects 14 to the content provider and retrieves 16 the media object or page.

As the media object is being received by the network access layer from the content provider 104, the parser begins to parse 17 the object. As parsing proceeds, the parser also begins to update 18 the global access cache 220 with the parsed portions of the object. Simultaneously, the parser begins the reply 20, 22 to the client via the network access layer.

In one implementation, the parser searches for images in the media objects to perform compression or pornography detection, for example. On encountering an image, the parser 214 passes a call to the media flow manager to process the image 24 while continuing to parse 26 the media object.

The media flow manager 210 gets the image 28 via the network access layer 214. The fact images are not stored with the page but must be separately requested is an artifact of the HTTP protocol. The network access layer 214 then connects 30 to the content provider 104 and retrieves 32 the image.

When the image is retrieved, the media flow manager 210 places it in the cache with the other portions of the media object and makes a function call to the object switch to process the image 34. The object switch knows the various service plugins that are available and the actions that must be performed on the media types that are discovered by the media parser, which in this example is an image. When called by the object switch 216 to process 36 the media type, the particular service plugin, or multiple plugins when serial operations are required, retrieves 38 the media type, i.e., image, and performs the desired operation on or processes 40 the image. For example, in one instance, this can be compression or thinning to expedite communication to the client. In another case, it can detect the probability of pornography by detecting the percentage of flesh-tone colors in the picture. Once the processing is complete, the new image or revised media object may be placed 42 in the cache 220 or used in a reply to the client 110, 116.

In many instances, the service plugin functionality will be performed by a separate compute server 105. This computer may be directly accessible by the media manipulator 100 or accessible through the local area network 112. Generally out-sourcing this functionality is desirable, rather than running on the same device with the other components of the media manipulator 100, to avoid depriving those other components of processing bandwidth.

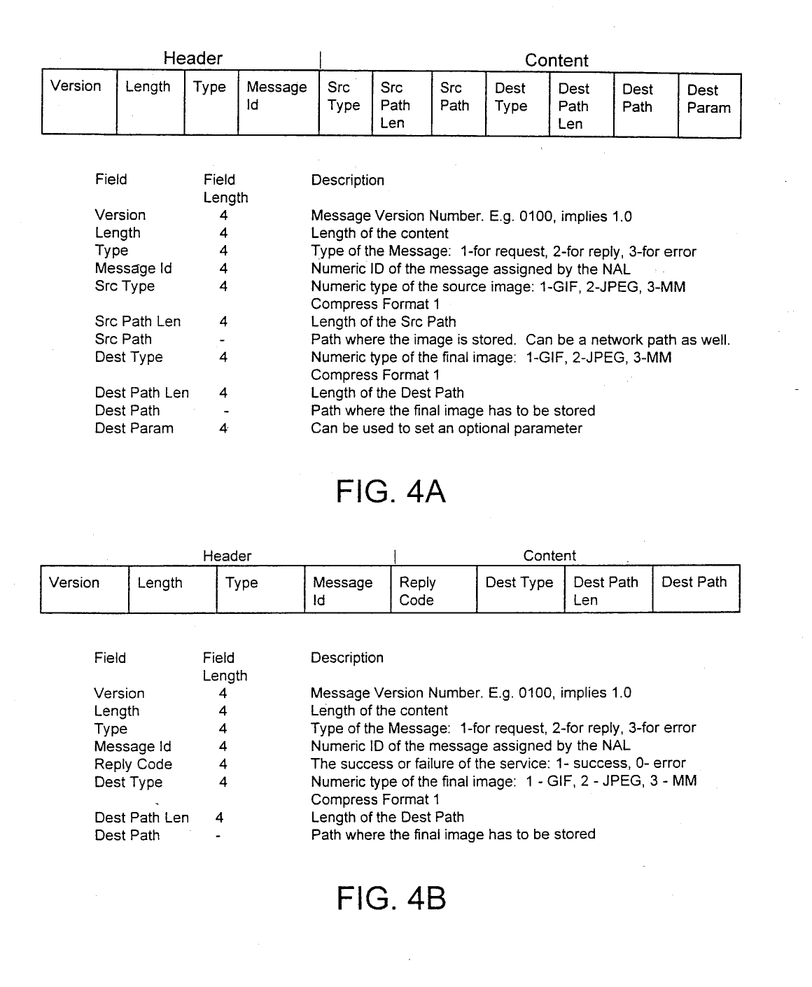

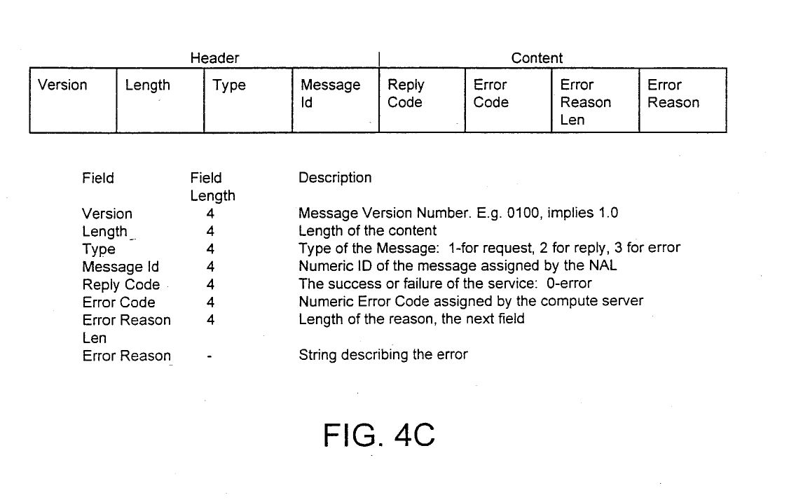

When the plugin does utilize the external compute server, it issues a request message. FIG. 4A illustrates the formatting of the message to the compute server. The message has a number of different fields. It has a version field and a length field defining the length of the content. The type field indicates the type of the message, and the message ID is assigned by the network access layer. The source type indicates the media type. In the context of image files, the type indicates whether the image is in a GIF or JPEG type compression format, for example. The source path is the path to where the image is stored in the global access cache 220, to which the compute server has access. The destination type, path length, path, and parameters define the transformed media type and where it is to be sent.

FIG. 4B illustrates the reply message from the compute server. It again has version, length, type, and message ID fields. The reply code indicates whether or not the service was successful. The destination type, path length, and path indicate the type of the final image after the transform of the compute server has been implemented and where that final image is stored in the global access cache or otherwise.

FIG. 4C shows the error message issued by the compute server when service was unsuccessful or error occurred. To contain this information, the message has a computer server error code identifying the server and a field holding the reason for the error.

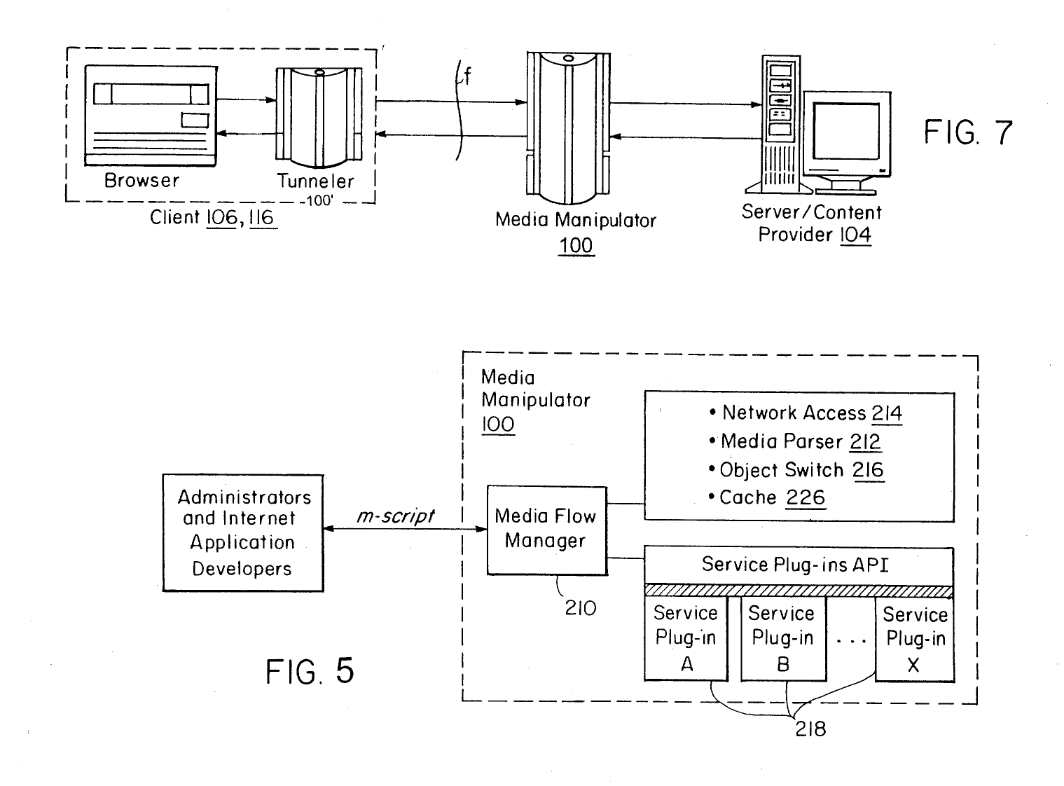

As illustrated in FIG. 5, the administrator or Internet application developer specifies the actions of the media manipulator by supplying an m-script language to the media flow manager 210. This is a quasi-configuration, script file which forms a high level programming language of the media manipulator. The following illustrates the general structure of the language with examples showing its use in the media manipulator 100.

name:=definition

The name of a rule is simply the name itself (without any enclosing “<” and “>”) and is separated from its definition by the colon-equal (“:=”) character.

“literal”

Quotation marks surround literal text. Unless stated otherwise, the text is case-sensitive.

rule1|rule2

Elements separated by a bar (“|”) are alternatives, e.g., “yes|no” will accept “yes” or “no”

{rule1 rule2 }

Elements enclosed in parentheses are treated as a single element. Thus, “{elem {foo|bar} elem}” allows the token sequences “elem foo elem” and “elem bar elem”.

rule*

The character “*” following an element indicates repetition. For example, “foo bar*”, implies, “foo” followed by zero or more of “bars”.

[rule]

Square brackets enclose optional elements. For example, “foo [bar]” implies, “foo” followed by zero or one of “bar”.

The BNF grammar of the m-script is grouped under three logical groups.

Basic

| | |
|---|---|
| Alphabets := | {abc . . . zABC . . . Z} |
| Variable-chars := | {abc . . . zABC . . . Z-_} |
| Numbers := | {0 . . . 9} |
| Variable-name := | Variable-chars {Variable-chars \| Numbers}* |
| Host-name := | Variable-chars {Variable-chars \| Numbers \| “.”}* |
| Path-name := | {Variable-chars \| Numbers \| “.” \| “/” \| “\” \| “˜” \| “:”}* |
| Others := | {!@#$%\hat{ }&*( )”{}-=\|\<>,} |
| EOLN := | “/n” |
| Comment := | “#” {Variable-chars \| Others \| “.” \| “/” \| “˜” \| “:” }* EOLN |

This section describes the basic rules used: Alphabets are composed of letters “a” through “z”, “A” through “Z”; Numbers are composed of digits zero through nine. Variables-chars are alphabets, dash (“-”) and underscore (“_”). A variable name must start with a Variable-char and followed by zero or many variable-chars or numbers. Host-name is similar to variable-name and in-addition can have periods (“.”). Path-name is a generic path used for locating files. EOLN is ASCII 13. A comment must start with “#” character and ends with an EOLN.

Generic

| | |
|---|---|
| m-script := | { comment \| section }* |
| Section := | section-key “{“ section-Desc “}” |
| Section-Desc := | section-line* |
| Section-line := | section-desc-key “=” section-desc-value [EOLN] |
| Section := | server-section \| cache-section \| service-section \| filter- |
| | section \| action-section |

This section describes a generic m-script file. An m-script is a comment or a section. A section must start with a Section-key, followed by a Section-description enclosed in parentheses. The section description is made up of zero or many section lines. A section line starts with a section description key followed by an equal sign (“=”) and the section description key's value. There are five types of sections, viz., server, cache, service, filter and action.

| Detail | |
|---|---|
| Server-section := | “server” “{“ server-sec-desc “}” |
| Server-sec-desc := | server-name-line \| server-port-line |
| Server-name-line := | “name” “=” host-name [EOLN] |
| Server-port-line := | “port” “=” numbers [EOLN] |

A server section starts with the key “server”. This section consists of two lines: Name and port lines. The name line specifies the name of the host on which the MM 100 is run. The port line specifies the main port number on which the MM awaits requests from clients.

| | |
|---|---|
| Cache-section := | “cache” “{“ cache-sec-desc “}” |
| Cache-sec-desc := | cache-clean-line \| cache-direc-line |
| Cache-clean-line := | “cleanup” “=” { number \| “no” } |
| Cache-direc-line := | “directory” “=” Path-name |

A cache section starts with the key “Cache”. This section consists of two lines as well: Cache-clean and directory lines. The cache-clean line specifies the time interval after which the cache cleaning is performed. It takes two values: a positive number (time interval in seconds) or the string “no”(implying never to be cleaned). The directory line specifies the directory in which the cached files need to be stored.

| | |
|---|---|
| Service-section := | “service” “{“ Service-sec-desc “}” |
| Service-sec-desc := | Service-id-line \| Service-host-line \| Service-port-line |
| Service-id-line := | “id” “=” variable-name |
| Service-host-line := | “host” “=” host-name |
| Service-port-line := | “port” “=” numbers |

A service section is for service plugins. There must be a service section for each service that has to be used by the MM 100. This section starts with the key “service”. The section consists of three lines: Id, Host and port lines. The id line specifies a user defined identifier that can be used in other sections. The host and port lines respectively specify the name of the host and port number on which the service is available.

| | |
|---|---|
| Filter-sec := | “filter” “{“ filter-desc “}” |
| Filter-desc := | filter-object-line \| filter-action-line |
| Filter-Object-line := | “object” “=” Filter-Object-Name |
| Filter-Object-Name := | “image” \| “video” \| “java” |
| Filter-Action-line := | “action” “=” variable-name |

A filter section starts with the key “filter”. This section consists of two lines: object and action line. The object line specifies the name of the object to be identified and filtered. The action line identifies the rule to be applied on the object. Currently, the objects identified are images. In future, objects like video and Java applets can be identified.

| | |
|---|---|
| Action-section := | “action” “{“ action-desc “}” |
| Action-desc := | action-id-line \| action-cond-line \| action-proc-line |
| Action-id-line := | “id” “=” variable-name |
| Action-cond-line := | “cond” “=” Action-cond-exp |
| Action-cond-exp := | [Action-exp-bin-op] Action-exp-var [ Action-cond-exp-op |
| | Action-cond-exp ] |
| Action-exp-bin-op := | “!” |
| Action-cond-exp-op := | “&&” \| “∥” \| “==” \| “!=” \| “>” \| “<” \| “>=” \| “<=” |
| Action-exp-var := | { Filter-Object-Name “.” Parameter } \| { variable-name “.” |
| | “result” } |
| Parameter := | “any” \| “transparent” \| “animated” |
| Action-proc-line := | “process” “=” Action-proc-exp |
| Action-proc-exp := | { variable-name\| Method-exp } [Action-connect Action-proc- |
| | exp ] |
| Method-exp := | Filter-Object-Name “.” Method-name “(“ Method-Param* “)” |
| Method-name := | “replace” |
| Method-Param := | “”” Path-name “”” |
| Action-connect := | “&” \| “\|” |

The action section is the most complicated section. The action sections can be linked to other action sections forming a list of actions to be applied in tandem. The section starts with the key “action”. This section consists of three lines: id, condition and process lines. The id, as before, is a user assigned identifier. The condition line specifies a condition when the process has to be performed. The condition is like a standard “C” expression. It uses object's properties (e.g., image.transparent—image that has a transparent bit), or result of other rules (e.g. rule1.result). The process can be a service identifier or another rule identifier. Several identifiers can be connected using action connectors: “&”(and) or “|”(or). The “&”(and) connector implies both the rules have to be applied in succession (e.g.: rule1 & rule2—implies apply rule1 and then rule2). The “|” (or) connector implies that apply either of the process (e.g.: compress1|compress2—implies, apply compress1 or compress2).

An example is as shown below:

| | |
|---|---|
| 1 | #m-script for manipulating HTML files |
| 2 | |
| 3 | #listening host name and port |
| 4 | server { |
| 5 | name = center |
| 6 | port = 8001 |
| 7 | } |
| 8 | |
| 9 | #cache parameters |
| 10 | cache{ |
| 11 | cleanup = no |
| 12 | directory = “/opt/mm/cache/images/” |
| 13 | } |
| 14 | |
| 15 | #compress service server 1 |
| 16 | service{ |
| 17 | id = compress1 |
| 18 | host = center |
| 19 | port = 7002 |
| 20 | } |
| 21 | |
| 22 | #compress service server 2 |
| 23 | service{ |
| 24 | id = compress2 |
| 25 | host = center |
| 26 | port = 7003 |
| 27 | } |
| 28 | |
| 29 | filter{ |
| 30 | object = image |
| 31 | action = rule1 |
| 32 | } |
| 33 | |
| 34 | action{ |
| 35 | id = rule1 |
| 36 | cond = image.any && ! image.transparent |
| 37 | process = compress1 \| compress2 |
| 38 | } |

| Line # | Explanation |
|---|---|
| 1. | A comment line starts with a “#” character. Everything to the |
| | end of that line is ignored. |
| 5 & 6 | The media manipulator listens on the host “center” and on port |
| | “8001” |
| 11 & | The files are cached (global cache) on the server. Keep them |
| 12 | longer. Store them in the directory specified. |
| 17-19 | Compute server id is “Compress1”. The host address is |
| | “center” and is listening on port “7002” |
| 24-26 | Compute server id is “Compress2”. The host address is |
| | “center” and is listening on port “7003” |
| 30 & | Filter the images and apply rule1 |
| 31 | |
| 35 | This section is rule1 |
| 36 | Do the process for any image that is not transparent. |
| 37 | Process images by sending to compress1 or to compress2 |

### EXAMPLE #2

Apart from compressing the images, the images can be tested for pornography. For this a service section has to be added and the action section has to be modified. The following m-script accomplishes this.

| | |
|---|---|
| 1 | #m-script for manipulating HTML files |
| 2 | #This compresses the images and detects them for pornography |
| 3 | |
| 4 | #listening host name and port |
| 5 | server { |
| 6 | name = center |
| 7 | port = 8001 |
| 8 | } |
| 9 | |
| 10 | #cache parameters |
| 11 | cache{ |
| 12 | cleanup = no |
| 13 | directory = “/opt/mm/cache/images/” |
| 14 | } |
| 15 | |
| 16 | #compress service server 1 |
| 17 | service{ |
| 18 | id = compress1 |
| 19 | host = center |
| 20 | port = 7002 |
| 21 | } |
| 22 | |
| 23 | #compress service server 2 |
| 24 | service{ |
| 25 | id = compress2 |
| 26 | host = center |
| 27 | port = 7003 |
| 28 | } |
| 29 | |
| 30 | #pornography detect service server 1 |
| 31 | service{ |
| 32 | id = porno1 |
| 33 | host = center |
| | port = 7010 |
| 34 | } |
| 35 | |
| 36 | #pornography detect service server 2 |
| 37 | service{ |
| 38 | id = porno2 |
| 39 | host = center |
| 40 | port = 7011 |
| 41 | } |
| 42 | |
| 43 | filter{ |
| 44 | object = image |
| 45 | action = all_image_rule |
| 46 | } |
| 47 | |
| 48 | action{ |
| 49 | id = all_image_rule |
| 50 | cond = image.any |
| 51 | process = compress_rule & porno_rule & destroy_rule |
| 52 | } |
| 53 | |
| 54 | action{ |
| 55 | id = compress_rule |
| 56 | cond = ! image.transparent |
| 57 | process = compress1 \| compress2 |
| 58 | } |
| 59 | |
| 60 | action{ |
| 61 | id = porno_rule |
| 62 | cond = compress_rule.result == 1 |
| 63 | process = porno1 \| porno2 |
| 64 | } |
| 65 | |
| 66 | action{ |
| 67 | id = destroy_rule |
| 68 | cond = porno_rule.result >= 75 |
| 69 | process = image.replace(“/opt/mm/lib/images/forbidden.gif”) |
| 70 | } |

| Line # | Explanation |
|---|---|
| 5-8 | Server section |
| 11-14 | Cache section |
| 16-28 | Compute servers “Compress1” and “Compress2” |
| 31-35 | Pornography detection service “porno1” is running in |
| | “center” and listening on port 7010 |
| 38-42 | Pornography detection service “porno1” is running in |
| | “center” and listening on port 7010 |
| 44-47 | Filter the images and apply all_image_rule |
| 49-52 | Apply action “all_image_rule” to all images. First apply |
| | compress_rule, followed by porno_rule and then by |
| | destroy_rule. |
| 55-59 | Apply action “compress_rule” to non-transparent images. Pass |
| | the images to either compress1 or compress2. |
| 61-65 | Apply action “porno_rule” to images. if compress_rule |
| | returned 1. Pass the compressed images to porno1 or porno2. |
| 67-71 | Apply action “destroy_rule” to images, if porno_rule returned a |
| | value greater than or equal to 75(probability of a pornographic |
| | image). Replace the image with “forbidden.gif”. |

Media Flow Manager (MFM)

MFM reads m-script and configures itself and other components based on the m-script. The MFM can be implemented as a multi-threaded object as shown below:

class MFM{
private:

int iPort;
char *strHostName;
char *strMFileName;
MediaParser *pMP;
GAC *pGAC;
ObjSw *pOS;
NAC *pNAC;
. . .

public:

MFM();
˜MFM();
int Configure(char *strMFileName);
int ProcessURL(char *strURL, . . . );
int ProcessImage(char *strSrcURL, int iHeight, int iWidth, . . . );
int CheckCacheUpdate( . . . );
int CreateInstance();
. . .

};

| | |
|---|---|
| Configure( . . . ) | Parses the m-Script file specified and configures |
| | the rest of the components. |
| ProcessURL( . . . ) | This is called by the parser, when it encounters a |
| | new image. This initiates the cache insertion on |
| | GAC. |
| ProcessImage( . . . ) | Mainly invoked by the MediaParser, when it |
| | encounters an image tag. This passes the com- |
| | mand to the appropriate object switch. |
| CreateInstance( . . . ) | This creates a new instance of the MFM by |
| | first copying the internal data structures and then |
| | creating a new thread. |

Media Parser—HTML Parser

The media parser can be implemented using generic tools like lex and yacc. The core of the parser can then be packaged to make parser objects.

class MediaParser{
private:

MFM *pMFM;
GAC *pGAC;
. . .

public:

MediaParser(MFM *pMFM, GAC *pGAC, . . . );
˜MediaParser();
int AddFilter(int iObjectType, . . . );
int Parse( . . . );
. . .

};

| | |
|---|---|
| AddFilter( . . . ) | Called by the MFM.Configure, adds to the list of |
| | objects that the MediaParser has to look for. |
| Parse( . . . ) | This is called by the NAL, when it successfully estab- |
| | lishes a connection with the client. This parses the |
| | media. When it encounters the object to be filtered, the |
| | parser notifies the MFM by invoking the appropriate |
| | function. |

Global Access Cache

The global access cache is a specialized cache system, specifically tuned to keep HTML pages and the images. The images can have multiple versions. These have to be cached separately. The cache is also cleaned regularly as described in the cache section of the m-script.

class GAC{
private:

char *apMainBuckets[MAX_HASH_KEY];
int Hash(char *strURL);
. . .

public:

GAC(MFM *pMFM, char *strPath, . . . );
˜GAC();
int SearchCache(char *strURL, . . . );
int PutInCache(char *strURL, char *strLocalFilename,
FILE *fp, . . . );
int UpdateCache(char *strURL, . . . );
int GetFromCache(char *strURL, int iKey, . . . );
. . .

};

| | |
|---|---|
| Hash( . . . ) | This is used to create the Hash key based on an |
| | URL. |
| SearchCache( . . . ) | This searches the cache for the given URL. |
| PutInCache( . . . ) | First searches the cache(SearchCache()) and if |
| | not found, inserts the URL int the cache. |
| UpdateCache( . . . ) | Updates the cache entry with related entries. For |
| | example, the URL entry can be updated with |
| | image entries that are related to the URL. |
| GetFromCache( . . . ) | Retrieves an URL or an Image. |

Network Access Layer

The network access layer for handling HTML pages, primarily deals with HTTP(Hyper Text Transmission Protocol). It accepts connection from the clients; makes connection to the content provider; requests and receives pages and images from the content provider. In addition to these the layer also provides connection to compute servers.

class NAL{
private:

int iPort;
char *strHostName;
int iNumCharsRead;
int iNumCharsWritten;
char *strURL;
. . .

public:

NAL(MFM *pMFM, MediaParser *pMP, . . . );
˜NAL();
int Listen(char *strHostName, int iPort, . . . );
int Accept( . . . );
int Connect(char *strHostName, int iPort, . . . );
int AcceptClients(char *strHostName, int iPort, . . . );
int GetImage(char *strHostName, int iPort, char *strURL . . . );
int GetURL(char *strHostName, int iPort, char *strURL, . . . );
int SendRequest( . . . );
int ReceiveReply( . . . );
. . .

};

| | |
|---|---|
| Listen( . . . ) | Creates a listening port. |
| Accept( . . . ) | Accepts any client requesting a connect. |
| Connect( . . . ) | Connects to the specified host and port number. |
| | Usually called by the GetImage() or GetURL() |
| GetImage( . . . ) | Connects to the ContentProvider and requests the |
| | image specified by the URL. This is responsible for |
| | building the appropriate request header etc |
| GetURL( . . . ) | Connects to the ContentProvider and requests the |
| | page specified by the URL. This is responsible for |
| | building the appropriate request header etc. |
| SendRequest( . . . ) | Sends a formatted message to the compute server. |
| | The format of the message is shown in the following |
| | section. |
| ReceiveReply( . . . ) | Receives a formatted message that is a reply to the |
| | message sent earlier. |

Service Plugin

The service sections describe the various servers available for the MM. Each service server is an instance of this object.

class ServPlugin{
private:

char *strId;
int iPort;
char *strHostName;
. . .

public:

ServPlugin(NAL *pNAL, char *strId,
char *strHostName, int iPort, . . . );
˜ServPlugin();
int Request(char *strSrcPath, char *strDestPath, . . . );
. . .
};

| | |
|---|---|
| Request( . . . ) | This initiates the request through the NAL. NAL sends |
| | the formatted message to the appropriate Compute |
| | Server. |

Object Switch
The object switch interfaces the MFM and the service plugins. The object
switch mostly implements the rules specified in the action section of the
m-script, as instructed by the MFM.
class ObjSw{
private:

MFM *pMFM;
GAC *pGAC;
ServPlugin *aSP; //array of service plugins
ActionList *alAction; //linked list of actions
—

public:

ObjSw(MFM *pMFM, GAC *pGAC, _);
˜ObjSw();
int AddServicePlugin(ServPlugin *pSP, _);
int AddAction(char *strId, char *strCond, char *strProcess, _);
int ProcessImage(_);
—

};

| | |
|---|---|
| AddServicePlugin(_) | This is invoked by the MFM during configuration |
| | phase. This adds the service plugin to its internal |
| | list. |
| AddAction(_) | This is also invoked by the MFM during the con- |
| | figuration phase. This adds the actions specified |
| | in the m-Script |
| ProcessImage(_) | Invoked by the MFM, this executes the actions in |
| | the specified order. |

Compute Server
The compute server executes as a separate processor or on a different
machine itself. It can be implemented as an object as well.
class CompServ{
private:

int iPort;
char *strHostName;
. . .

public:

CompServ();
˜CompServ();
int ReceiveRequest(char *strSrcPath, char *strDestPath, . . . );
int ProcessRequest( . . . );
int Reply( . . . );
. . .

};

| | |
|---|---|
| ReceiveRequest( . . . ) | This receives the formatted message. |
| ProcessRequest( . . . ) | This processes the request. The user can extend |
| | the compute server by adding capabilities to this |
| | method. |
| Reply( . . . ) | Sends the reply. |

The compute server can also use the NAL to send and receive messages.

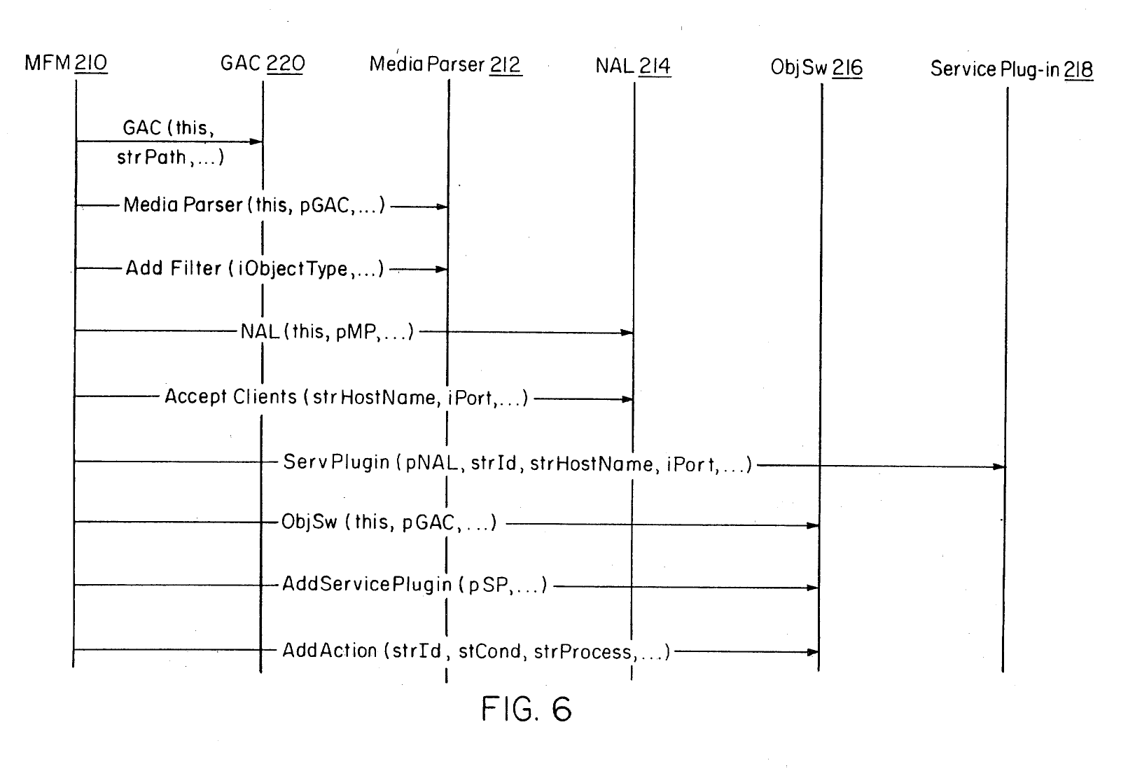

FIG. 6 is an object interaction diagram showing the order of creation of the objects/components of the manipulator 100 and the order in which the m-script is processed or read. Of note is the fact that the object switch 216 is called after service plugins 218. This order ensures that the services are all declared. AddAction takes the pointer to those service plugins, and AddServicePlugin identifies the compute server executing the plugin, its host name, and its port. ObjSw ensures the GAC 220 may be updated by the object switch with the results of the service, once executed.

FIG. 7 illustrates another embodiment of the inventive media manipulator 100. The media manipulator described in the previous sections was used as an intermediate processor between the client 106, 116 and the content provider server 104. In this alternative embodiment, an additional, stripped down tunneler version of the manipulator 100′ can be used to interact between the client 106, 116 and the media manipulator 100 as described previously. These two instances of the manipulator 100, 100′ can now perform in unison to further enhance the user experience.

The tunneler media manipulator 100′ and the media manipulator 100 exchange a compressed format suitable for the transmission over a low-bandwidth connection, while the tunneler 100′ and the browser(client) exchange information in the client's native format. Apart from these, the client 106, 116 can be inside a firewall f and still use the services of a main media manipulator 100, which may be outside the firewall f. The tunneler 100′ can also be used to set various options such as compression quality, specific to the client's need. These options are forwarded to the main media manipulator 100 along with the client's request. The main media manipulator 100 can categorically act on both the tunneler's and client's request.

Apart from compressing images, the tunneler 100′ and main media manipulator 100 combination can be used to compress the HTML page itself. The HTML page is a media, and if the service is available to compress it, the m-script can be modified appropriately to send the page to the text-compress-plugin before sending towards the client. The tunneler can intercept this and decompress the page.

The tunneler 100′ has following components of the media manipulator: 1) media flow manager 210, 2) media parser 212, 3) object switch 216, 4) network access layer 214, and 5) service plugin 218. It does not the global access cache 220. The service plugin in the tunneler 100′ is the compliment of what is used in the media manipulator to decompress the images.

While this invention has been particularly shown and described with references to preferred embodiments thereof, it will be understood by those skilled in the art that various changes in form and detail may be made therein without departing from the spirit and scope of the invention as defined by the appended claims.

What is claimed is:

1. A middle-ware computing system comprising:
a network access system that supports communications with media resources and client computers;
a media manipulation system that operates on media objects received from the media resources via the network access system prior to forwarding the media objects to the client computers and includes a parser that identifies different media types within the media objects.

2. The computing system described in claim 1, wherein the media manipulation system further comprises service devices that operate on the media types.

3. The computing system described in claim 2, wherein the parser searches for images in the media objects and service devices include an image compressor for performing data compression on the images.

4. The computing system described in claim 2, wherein the parser searches for executable files in the media objects and service devices include a virus scanner that searches for computer viruses in the files.

5. The computing system described in claim 2, wherein the parser searches for images in the media objects and service devices include an pornography detector for assessing a probability that the images are pornographic.

6. The computing system described in claim 2, wherein the parser searches for data files in the media objects and service devices include an format converter for changing a format of the data files.

7. The computing system described in claim 2, wherein the media manipulation system further comprises an object switch that passes the media types to the service devices to determine operations performed on the different media types.

8. The computing system described in claim 2, wherein the media manipulation system further comprises a media flow manager that reassembles the media objects for forwarding to the clients after the manipulation of the media types.

9. The computing system described in claim 8, further comprising a cache that stores media objects, the media flow manager receiving requests for media objects and checking for the presence of the media objects in the cache to preclude obtaining the objects from the media resources.

10. A middle-ware computing system comprising:
a network access system that supports communications with media resources to obtain media objects from client computers;
a parser that identifies different media types within the media objects;
service devices that manipulate the media types;
an object switch that passes the media types to the service devices to determine operations performed on the different media types; and
a media flow manager that reassembles the media objects for forwarding to the clients after the manipulation of the media types.

11. The computing system described in claim 10, further comprising a cache that stores media objects, the media flow manager receiving requests for media objects and checking for the presence of the media objects in the cache to preclude obtaining the objects from the media resources.

12. A method for facilitating transmission of media objects between media resources and client computers, the method comprising:
receiving requests for media objects from the client computers to the media resources;
obtaining the media objects;
manipulating the media objects;
forwarding the manipulated media objects to the client computers.

13. The method described in claim 12, wherein manipulating the media objects comprises:
identifying different media types within the media objects; and
performing separate operations on the different media types.

14. The method described in claim 13, wherein the step of identifying different media types comprises searching for images in the media objects and the step of performing operations comprises data compressing the images.

15. The method described in claim 13, wherein the step of identifying different media types comprises searching for executable files in the media objects and the step of performing operations comprises scanning the files for computer viruses.

16. The method described in claim 13, wherein the step of identifying different media types comprises searching for images in the media objects and the step of performing operations comprises assessing a probability that the images are pornographic.

17. The method described in claim 13, wherein the step of identifying different media types comprises searching for data files in the media objects and the step of performing operations changing a format of the data files.

18. The method described in claim 13, further comprising reassembling the media objects for forwarding to the clients after the manipulation of the media types.

19. The method described in claim 13, further comprising routing the media types to form successive operations on the media types.

20. The method described in claim 12, further comprising caching media objects that have been received from the media resources and later obtaining the media objects from the cache.

21. The method described in claim 20, wherein the step of obtaining the media objects requesting the media objects from the media resources while checking for the objects in a cache; and obtaining the media objects from the cache if present.
